(19) United States
(12) Patent Application Publication
(10) Pub. No.: US 2024/0270999 A1
(43) Pub. Date: Aug. 15, 2024

(54) SELF-HEALING RESIN COMPOSITION AND ARTIFICIAL LEATHER MANUFACTURED THEREFROM

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Ren-Yu Liao, New Taipei City (TW)

(21) Appl. No.: 18/313,357

(22) Filed: May 7, 2023

(30) Foreign Application Priority Data
Feb. 3, 2023 (TW) 112103762

(51) Int. Cl. C09D 175/04; C09D 7/42; C09D 7/63; C09D 7/65; D06N 3/00; D06N 3/14

(52) U.S. Cl. CPC C09D 175/04; C09D 7/42; C09D 7/63; C09D 7/65; D06N 3/0002; D06N 3/0059; D06N 3/143; D06N 3/146; D06N 2201/0236; D06N 2201/0281; D06N 2203/068

(57) ABSTRACT

A self-healing resin composition includes 35 phr to 110 phr of a main resin, 10 phr to 30 phr of a self-healing component, a hardener, a matting agent, and a solvent. The main resin contains a diol monomer and a diisocyanate monomer. The self-healing component includes at least one of a cyclosiloxane and a self-healing component as represented in a formula (I) of:

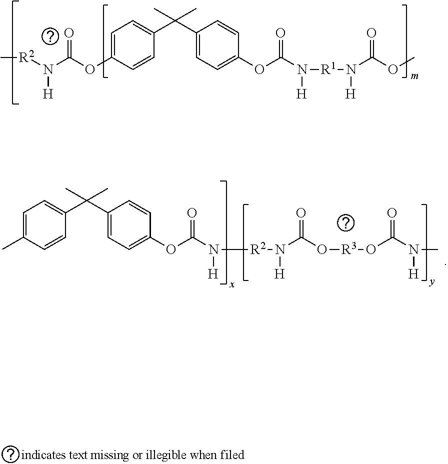

R¹ is formed from a first isocyanate, R² is formed from a second isocyanate, and R³ is selected from the group consisting of:

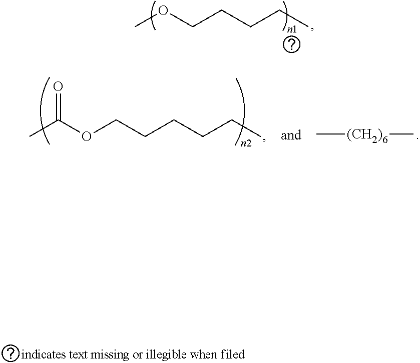

“x” is an integer ranging from 3 to 50. “y” is an integer ranging from 3 to 50. “m” is an integer ranging from 3 to 50. “n1” is an integer ranging from 3 to 50. “n2” is an integer ranging from 3 to 50.

### CROSS-REFERENCE TO RELATED PATENT APPLICATION

This application claims the benefit of priority to Taiwan Patent Application No. 112103762, filed on Feb. 3, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition and artificial leather manufactured therefrom, and more particularly to a self-healing resin composition and artificial leather manufactured therefrom.

### BACKGROUND OF THE DISCLOSURE

Commercially available artificial leather has insufficient scratch resistance such that permanent scratches are easily formed on the artificial leather and the appearance of the artificial leather is negatively affected. In order to prolong service life of the artificial leather, a protection layer is coated on a surface of the artificial leather.

With the advancement of technology and the discovery of self-healing materials, the self-healing materials have been gradually applied to the artificial leather. Accordingly, when scratches are formed on the artificial leather by external force, heating the artificial leather can allow the artificial leather to return to the original appearance. However, the conventional self-healing materials have a high gloss which causes difficulty in forming a matte layer.

In order to increase a haze of the self-healing materials, the self-healing materials undergoes a matte treatment, and scattering particles are added into the self-healing materials in the related art. However, the matte treatment changes the properties of the self-healing materials, and the addition of the scattering particles may generate a problem of fallen scattering particles. Therefore, how to adjust the components of the self-healing resin composition has become one of the important issues to be addressed in the industry.

### SUMMARY OF THE DISCLOSURE

In response to the above-referenced technical inadequacy, the present disclosure provides a self-healing resin composition. The self-healing resin composition includes 35 phr to 110 phr of a main resin, 10 phr to 30 phr of a self-healing component, a hardener, a matting agent, and a solvent. The main resin contains a diol monomer and a diisocyanate monomer. The self-healing component includes at least one of a cyclosiloxane and a self-healing component as represented in formula (I):

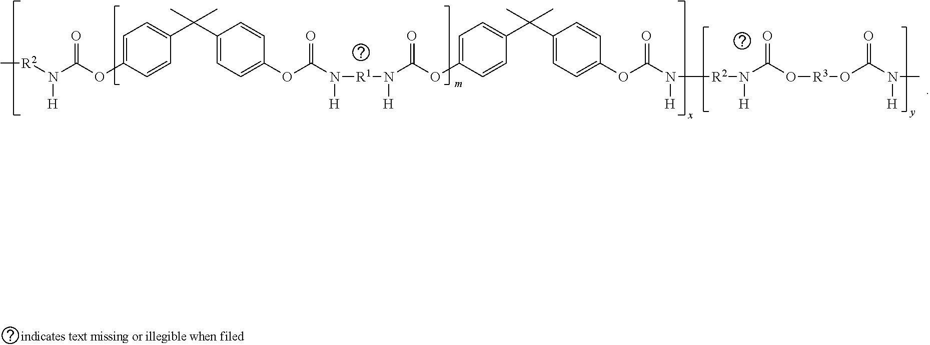

R¹ is formed from a first isocyanate, R² is formed from a second isocyanate, and R³ is selected from the group consisting of:

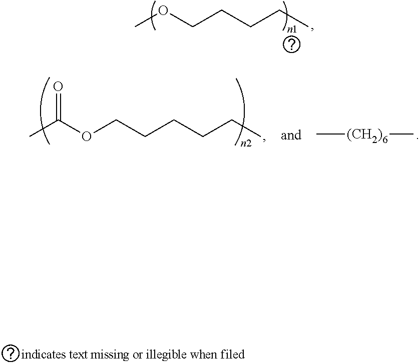

“x” is an integer ranging from 3 to 50. “y” is an integer ranging from 3 to 50. “m” is an integer ranging from 3 to 50. “n1” is an integer ranging from 3 to 50. “n2” is an integer ranging from 3 to 50.

In certain embodiments, the cyclosiloxane includes bis(heptamethylcyclotetrasiloxanyl)ethane, octamethylcyclotetrasiloxane, or a combination thereof.

In certain embodiments, the diol monomer includes butylene glycol, hexylene glycol, and polycarbonate diol.

In certain embodiments, the main resin includes 5 phr to 20 phr of butylene glycol, 10 phr to 30 phr of hexylene glycol, and 10 phr to 30 phr of polycarbonate diol.

In certain embodiments, the diisocyanate monomer includes methylene diphenyl diisocyanate.

In certain embodiments, the main resin includes 10 phr to 40 phr of methylene diphenyl diisocyanate.

In certain embodiments, based on a total weight of the self-healing resin composition being 100 phr, an amount of the matting agent ranges from 0.1 phr to 3 phr.

In certain embodiments, the first isocyanate is selected from the group consisting of: hexamethylene diisocyanate, 4,4′-diisocyanato dicyclohexylmethane, methylene diphenyl diisocyanate, and isophorone diisocyanate, and the second isocyanate is selected from the group consisting of: hexamethylene diisocyanate, 4,4′-diisocyanato dicyclohexylmethane, methylene diphenyl diisocyanate, and isophorone diisocyanate.

In one aspect, the present disclosure provides artificial leather. The artificial leather includes a leather layer and a self-healing layer. The self-healing layer is disposed on the leather layer. The self-healing layer is formed from the abovementioned self-healing resin composition.

In certain embodiments, a thickness of the self-healing layer ranges from 10 μm to 100 μm.

In certain embodiments, a haze of the self-healing layer ranges from 3% to 20%.

In certain embodiments, the leather layer is a polyurethane leather layer or a polyvinyl chloride leather layer.

Therefore, in the self-healing resin composition and the artificial leather manufactured therefrom provided by the present disclosure, by virtue of “at least one of a cyclosiloxane and a self-healing component as represented in formula (I),” the self-healing effect of the self-healing resin composition can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of artificial leather of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A self-healing resin composition is provided in the present disclosure. The self-healing resin composition can be applied to a manufacturing method for artificial leather and solidified to form a self-healing material. The self-healing material has a self-healing effect. At a temperature ranging from 80° C. to 130° C., the self-healing material can repair scratches through an intermolecular force. Therefore, the self-healing resin composition can be applied to artificial leather to form a self-healing layer (i.e., the self-healing material) on a leather layer.

By choosing components, designing molecular structures, and modifying functional groups, the self-healing material can have the self-healing effect. In addition, the self-healing resin composition can be used to form a self-healing layer having a high haze which can be distinguished from the conventional high-gloss self-healing layer.

The self-healing resin composition includes 35 phr to 110 phr of a main resin, 10 phr to 30 phr of a self-healing component, 5 phr to 40 phr of a hardener, 1 phr to 3 phr of a matting agent, and 60 phr to 400 phr of a solvent.

The main resin contains a diol monomer and a diisocyanate monomer. By using different monomers, the self-healing resin composition after being solidified (i.e., the self-healing material) can have more hydrogen bonds. When being deformed by external force, under an appropriate temperature, the self-healing material can return to an original shape.

For example, the diol monomer includes butylene glycol, hexylene glycol, and polycarbonate diol. The diisocyanate monomer includes methylene diphenyl diisocyanate. Choosing butylene glycol, hexylene glycol, and polycarbonate diol as the diol monomers and choosing methylene diphenyl diisocyanate as the diisocyanate monomer can enhance a self-healing effect of the polyurethane elastomer formed from the main resin.

In an exemplary embodiment, the main resin includes 5 phr to 20 phr of butylene glycol, 10 phr to 30 phr of hexylene glycol, 10 phr to 30 phr of polycarbonate diol, and 10 phr to 40 phr of methylene diphenyl diisocyanate.

The addition of the self-healing component can help a material to return to an original state. When scratches are formed or deformation has occurred on the material, the material can be appropriately heated to return to the original state through thermal expansion (i.e., a physical repair) or through reconnection of broken parts (i.e., a chemical repair).

The self-healing component includes at least one of a cyclosiloxane and a self-healing component as represented in formula (I).

The cyclosiloxane can provide a large amount of silane covalent bonds which can achieve the self-healing effect (e.g., heating and then repairing).

The cyclosiloxane includes an octatomic ring consisting of oxygen atoms and silicon atoms. Specifically, the cyclosiloxane can be bis(heptamethylcyclotetrasiloxanyl)ethane, octamethylcyclotetrasiloxane, or a combination thereof.

In an exemplary embodiment, when the self-healing component only includes the cyclosiloxane, the self-healing resin composition can include 5 phr to 15 phr of butylene glycol, 5 phr to 20 phr of hexylene glycol, 10 phr to 30 phr of polycarbonate diol, 10 phr to 20 phr of methylene diphenyl diisocyanate, and 30 phr to 40 phr of the cyclosiloxane.

The self-healing component as represented in formula (I) contains a large amount of phenol carbamate feature units (N—C(═O)—O-Ph). Therefore, when the material is deformed or damaged, the material can be repaired via the phenol carbamate feature units.

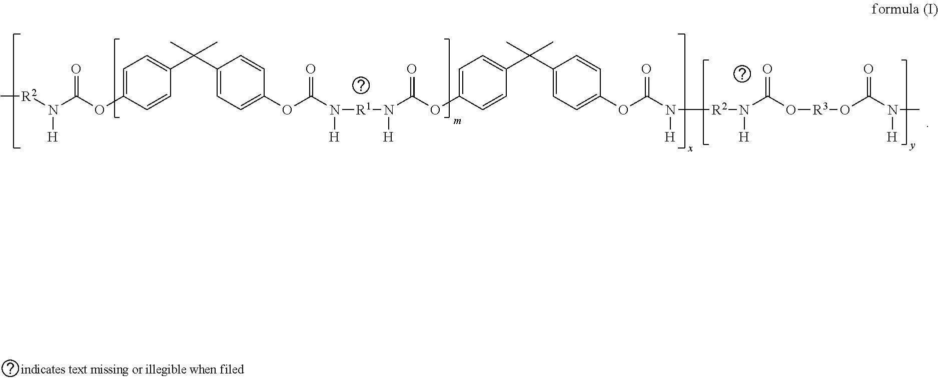

In formula (I), R¹ is formed from a first isocyanate. R² is formed from a second isocyanate. R³ is selected from the group consisting of:

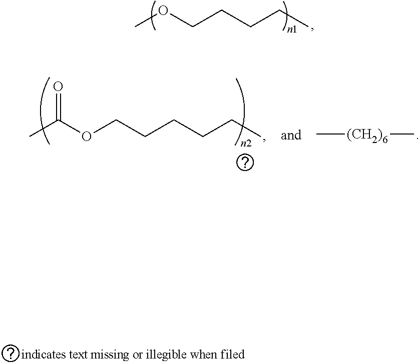

“x” is an integer ranging from 3 to 50. “y” is an integer ranging from 3 to 50. “m” is an integer ranging from 3 to 50. “n1” is an integer ranging from 3 to 50. “n2” is an integer ranging from 3 to 50.

In an exemplary embodiment, the first isocyanate can be selected from the group consisting of: hexamethylene diisocyanate (HDI), 4,4′-diisocyanato dicyclohexylmethane (H12MDI), methylene diphenyl diisocyanate (MDI), and isophorone diisocyanate (IPDI). The second isocyanate can be selected from the group consisting of: hexamethylene diisocyanate, 4,4′-diisocyanato dicyclohexylmethane, methylene diphenyl diisocyanate, and isophorone diisocyanate. In other words, the first isocyanate and the second isocyanate can be the same isocyanate.

In an exemplary embodiment, when the self-healing component only includes the self-healing component as represented in formula (I), the self-healing resin composition can include 5 phr to 15 phr of butylene glycol, 10 phr to 20 phr of hexylene glycol, 10 phr to 30 phr of polycarbonate diol, 10 phr to 20 phr of methylene diphenyl diisocyanate, and 10 phr to 30 phr of cyclosiloxane.

It should be noted that the cyclosiloxane and the self-healing component as represented in formula (I) can interact with each other and produce synergistic effects, so as to achieve a better self-healing effect.

A synthesis method of the self-healing component as represented in formula (I) is described in the following description.

In order to form the self-healing layer having a high haze, the main resin and the self-healing component chosen in the present disclosure have relatively high haze, such that the usage amount of the matting agent can be reduced and a good matting effect still can be achieved. Moreover, the addition of the self-healing component can stabilize the matting agent and prevent the matting agent falling off after being used for a long time.

In an exemplary embodiment, the hardener can be, but not limited to: benzoyl peroxide. The matting agent can be, but not limited to: bis(tetramethylammonium)oligodimethylsiloxanediolate. The solvent can be, but not limited to: butanone, N,N-diethylformamide (DEF), or a combination thereof.

### Example 1

The self-healing component in Example 1 only includes the self-healing component as represented in formula (I).

The self-healing component as represented in formula (I) is synthesized by the following steps. MDI and butylene glycol are reacted in advance at a temperature of 100° ° C. for 2 hours. Bisphenol A is added for further reaction at a temperature of 100° C. for 1 hour, and then the self-healing component as represented in formula (I) is synthesized. A molar ratio of MDI to butylene glycol to bisphenol A is 5:3:2.

Afterwards, the self-healing component as represented in formula (I) is used to prepare the self-healing resin composition.

According to contents as shown in Table 1, butanone and DEF are mixed to form a mixed solvent at room temperature. Butylene glycol, hexylene glycol, polycarbonate diol, and methylene diphenyl diisocyanate are dissolved in the mixed solvent, and then the self-healing component as represented in formula (I), benzoyl peroxide, and bis(tetramethylammonium)oligodimethylsiloxanediolate are added to the mixed solvent to form a resin mixture. The resin mixture is uniformly mixed and reacted at a temperature of 100° ° C. for 3 hours so as to obtain the self-healing resin composition of the present disclosure.

### Example 2

The self-healing component in Example 2 includes bis(heptamethylcyclotetrasiloxanyl)ethane and octamethylcyclotetrasiloxane (i.e., cyclosiloxane).

The cyclosiloxane is used to prepare the self-healing resin composition. According to contents shown in Table 1, butanone and DEF are mixed to form a mixed solvent at room temperature. Butylene glycol, hexylene glycol, polycarbonate diol, and methylene diphenyl diisocyanate are dissolved in the mixed solvent, and then bis(heptamethylcyclotetrasiloxanyl)ethane and octamethylcyclotetrasiloxane (cyclosiloxane), benzoyl peroxide, and bis(tetramethylammonium)oligodimethylsiloxanediolate are added to the mixed solvent to form a resin mixture. The resin mixture is uniformly mixed and reacted at a temperature of 100° C. for 3 hours so as to obtain the self-healing resin composition of the present disclosure.

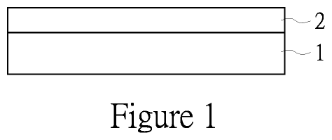

Referring to FIG. 1, the self-healing resin composition of the present disclosure can be applied to a leather layer 1. After the self-healing resin composition coated on the leather layer 1 is dried, a self-healing layer 2 is formed from the self-healing resin composition. The leather layer 1 can be a polyurethane leather layer or a polyvinyl chloride leather layer, but it is not limited thereto.

In order to test the self-healing effect of the self-healing layer 2, the self-healing resin compositions in Examples 1 and 2 are coated on the leather layer 1 to have a thickness ranging from 10 μm to 100 μm, and are dried at a temperature ranging from 60° C. to 120ºC for 2 minutes to 5 minutes, so that the self-healing layer 2 is formed on the leather layer 1 and samples to be tested are obtained.

The hazes of the samples are measured by a haze meter, and results are listed in Table 1.

Scratches are formed on the samples by using a copper brush, and the scratched samples are then placed under a temperature of 80° C. for 2 minutes. Subsequently, the self-healing layer 2 is observed to evaluate the self-healing effect, and results are listed in Table 1.

TABLE 1

| | | Example | |
|---|---|---|---|
| (phr) | | 1 | 2 |
| Main resin | Butylene glycol | 5 | 5 |
| | Hexylene glycol | 5 | 5 |
| | Polycarbonate diol | 8 | 8 |
| | Methylene diphenyl diisocyanate | 9 | 9 |
| Self- | Self-healing component as represented in | 8 | — |
| healing | formula (I) | | |
| component | Bis(heptamethylcyclotetrasiloxanyl)ethane | — | 4 |
| | Octamethylcyclotetrasiloxane | — | 4 |
| Hardener | Benzoyl peroxide | 4.6 | 4.6 |
| Matting | Bis(tetramethylammonium) | 0.4 | 0.4 |
| agent | oligodimethylsiloxanediolate | | |
| Solvent | Butanone | 40 | 40 |
| | N,N-diethylformamide | 20 | 20 |

| | | |
|---|---|---|
| Haze of self-healing layer | 10% | 10% |
| Self-healing effect | Good | Good |

According to the results listed in Table 1, the self-healing material formed from the self-healing resin composition of the present disclosure has the self-healing effect. After the scratched artificial leather is heated at a temperature of 80ºC for 2 minutes, the scratches on the artificial leather cannot be observed by naked eye. In addition, the self-healing resin composition can be used to form the self-healing layer having a high haze which can be distinguished from the conventional high-gloss self-healing layer.

### Beneficial Effects of the Embodiments

In conclusion, in the self-healing resin composition and artificial leather manufactured therefrom provided by the present disclosure, by virtue of “at least one of a cyclosiloxane and a self-healing component as represented in formula (I),” a self-healing effect of the self-healing resin composition can be enhanced.

Further, by choosing the specific diol monomer and the diisocyanate monomer, the solidified self-healing resin composition (the self-healing material) can have lots of hydrogen bonds. After being deformed by external force, the self-healing material can return to its original shape at an appropriate temperature. Moreover, the specific main resin can decrease the usage amount of the matte agent and uniformly disperse the matte agent in the self-healing resin composition.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A self-healing resin composition, comprising:
35 phr to 110 phr of a main resin that contains a diol monomer and a diisocyanate monomer;
10 phr to 30 phr of a self-healing component that includes at least one of a cyclosiloxane and a self-healing component as represented in a formula of: 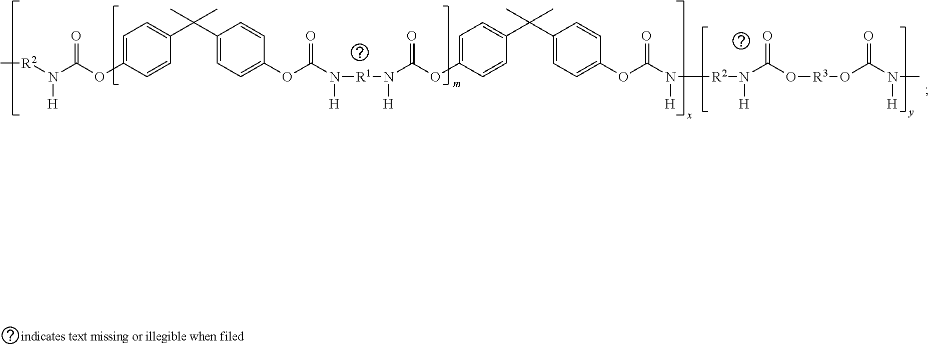
wherein R¹ is formed from a first isocyanate, R² is formed from a second isocyanate, and R³ is selected from the group consisting of: 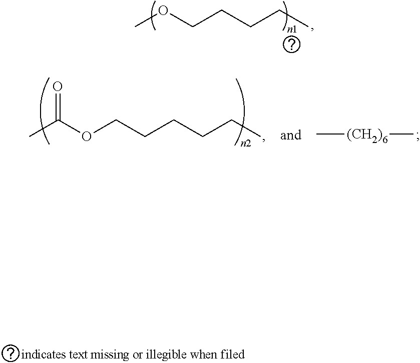
wherein “x” is an integer ranging from 3 to 50, “y” is an integer ranging from 3 to 50, “m” is an integer ranging from 3 to 50, “n1” is an integer ranging from 3 to 50, and “n2” is an integer ranging from 3 to 50;
a hardener;
a matting agent; and
a solvent.

2. The self-healing resin composition according to claim 1, wherein the cyclosiloxane includes bis(heptamethylcyclotetrasiloxanyl)ethane, octamethylcyclotetrasiloxane, or a combination thereof.

3. The self-healing resin composition according to claim 1, wherein the diol monomer includes butylene glycol, hexylene glycol, and polycarbonate diol.

4. The self-healing resin composition according to claim 3, wherein the main resin includes 5 phr to 20 phr of butylene glycol, 10 phr to 30 phr of hexylene glycol, and 10 phr to 30 phr of polycarbonate diol.

5. The self-healing resin composition according to claim 1, wherein the diisocyanate monomer includes methylene diphenyl diisocyanate.

6. The self-healing resin composition according to claim 5, wherein the main resin includes 10 phr to 40 phr of methylene diphenyl diisocyanate.

7. The self-healing resin composition according to claim 1, wherein, based on a total weight of the self-healing resin composition being 100 phr, an amount of the matting agent ranges from 0.1 phr to 3 phr.

8. The self-healing resin composition according to claim 1, wherein the first isocyanate is selected from the group consisting of: hexamethylene diisocyanate, 4,4′-diisocyanato dicyclohexylmethane, methylene diphenyl diisocyanate, and isophorone diisocyanate, and the second isocyanate is selected from the group consisting of: hexamethylene diisocyanate, 4,4′-diisocyanato dicyclohexylmethane, methylene diphenyl diisocyanate, and isophorone diisocyanate.

9. An artificial leather, comprising:
a leather layer; and
a self-healing layer disposed on the leather layer, wherein the self-healing layer is formed from the self-healing resin composition as claimed in claim 1.

10. The artificial leather according to claim 9, wherein a thickness of the self-healing layer ranges from 10 μm to 100 μm.

11. The artificial leather according to claim 9, wherein a haze of the self-healing layer ranges from 3% to 20%.

12. The artificial leather according to claim 9, wherein the leather layer is a polyurethane leather layer or a polyvinyl chloride leather layer.
